(19) United States
(12) Patent Application Publication
(10) Pub. No.: US 2026/0334685 A1
(43) Pub. Date: Oct. 29, 2026

(54) RETRACTABLE ARMREST APPARATUS FOR A FURNITURE ITEM

(71) Applicant: SECRETLAB SG PTE. LTD., Singapore (SG)

(72) Inventors: Vincent SIN, Singapore (SG); Cheng Feng Elroy LEE, Singapore (SG); Lester Zhe Ming NEO, Singapore (SG); Andrew Kenn HO, Singapore (SG)

(21) Appl. No.: 19/190,845

(22) Filed: Apr. 28, 2025

(51) Int. Cl. A47C 7/54; F16B 2/18

(52) U.S. Cl. CPC A47C 7/546; A47C 7/541; F16B 2/185

(57) ABSTRACT

Disclosed is an armrest apparatus for a furniture item, comprising an armrest apparatus for a furniture item, the armrest apparatus comprising a mounting plate comprising a mount; a cam locking assembly attached to the mounting plate and configured to receive an armrest for the furniture item, wherein the mount is configured to mount the cam locking assembly to a supportive base of the furniture item. Further disclosed is a kit of parts of an armrest apparatus assembly, a method for manufacturing the armrest apparatus, and a method of fitting the armrest apparatus on a furniture item.

### TECHNICAL FIELD

Various aspects of this disclosure relate to an armrest apparatus for a furniture item, a kit of parts of an armrest apparatus assembly, a method of manufacturing the armrest apparatus, and a method of fitting the armrest apparatus onto the furniture item.

### BACKGROUND

The following discussion of the background is intended to facilitate an understanding of the present disclosure only. It should be appreciated that the discussion is not an acknowledgement or admission that any of the material referred to was published, known, or is part of the common general knowledge of the person skilled in the art in any jurisdiction as of the priority date of the disclosure.

Conventional chairs include a non-foldable armrest for supporting the user's arm when the user is using the chair. A user may however, desire additional space for free articulation of the user's arm, for example when performing activities such as playing video games, or playing a guitar. In such settings, the non-foldable armrest of the chair may hinder the user's arm movements. To obtain the additional space required, the user may need to remove the armrest from the chair and re-install the armrest after the activities are completed, which may be tedious and cumbersome for the user. Further, a chair with the armrest permanently removed may affect the user's comfort.

One conventional solution includes chairs with foldable armrests. Such armrests are attached to the back rest of the chair and include a single pivot at the base of the armrest to allow the armrest to fold. For example, the armrest may fold by swiveling out to the side, rotating upwards, or rotating downwards. To provide sufficient space for the armrest to fold, in the upright position when the armrest is not folded, the armrest has to be positioned at a wide distance, relative to the seat base of the chair. This compromises the ergonomic support of the armrest, as in the upright position, the user would need to extend outwards to rest their arm on the armrest. This may cause discomfort to the user, in particular, during prolonged use of chairs with such foldable armrests.

Therefore, there is a need for an improved armrest apparatus, and/or a method of manufacturing the armrest apparatus, that seeks to address at least one of the aforementioned issues.

### SUMMARY

The disclosure was conceptualized to provide an improved armrest apparatus for a furniture item. The improved armrest apparatus includes a mounting plate having a cam locking assembly attached thereto, the cam locking assembly configured to receive the armrest and to move the armrest from a first position, e.g. upright or non-folded position, where the armrest is able to support the user's arm, and a second position, e.g. retracted or folded position, in which the armrest is not required to support the user's arm. To this end, the improved armrest apparatus includes a mount for enabling the cam locking assembly to be mounted to a supportive base of the furniture item, thereby providing a narrower distance, e.g. 0 cm-2.5 cm, between the supportive base of the furniture item and the armrest. In various embodiments, the armrest may be in direct contact with the supportive base of the furniture item. This provides a stable armrest which retains optimal ergonomic support for supporting the user's arm in the first, e.g. upright or non-folded position, as the user no longer has to extend their arm outwards to rest their arm on the armrest, and provides an armrest which is able to move into the second position, e.g. retracted or folded position when desired. Furthermore, the cam locking assembly of the improved armrest apparatus features a two-axis rotation, e.g. swivel mechanism for moving the armrest into the second, e.g. retracted position—by rotating the armrest along the lateral and longitudinal planes of the cam locking assembly. The two-axis rotation mechanism allows the armrest to retract with sufficient clearance, and enables the armrest to be stably supported in the first, e.g. upright position.

The improved armrest apparatus thus provides a foldable armrest that provides optimal ergonomic support for the user, and provides a dual-axis rotation mechanism for retracting the armrest into the second, e.g. retracted position. In addition, embodiments of the disclosure provide a simple and inexpensive manufacturing process of the improved armrest apparatus.

The improved armrest apparatus is particularly suitable for providing an armrest for an ergonomic chair, e.g. an office chair, a gaming chair.

According to a first aspect of the disclosure, there is provided an armrest apparatus for a furniture item, the armrest apparatus comprising: a mounting plate comprising a mount; a cam locking assembly attached to the mounting plate and configured to receive an armrest for the furniture item, wherein the mount is configured to mount the cam locking assembly to a supportive base of the furniture item.

In various embodiments, the mount comprises at least one mounting hole arranged on the mounting plate, the at least one mounting hole configured to receive a fastener to mount the cam locking assembly to the supportive base of the furniture item. In some embodiments, the at least one mounting hole comprises at least one elongated shaped hole.

In various embodiments, the cam locking assembly comprises a lever operable to move the armrest from a first position in which the armrest extends from the mounting plate in a first direction, and a second position in which the armrest extends from the mounting plate in a second direction different to the first direction. In some embodiments, the second direction is substantially perpendicular to the first direction.

In various embodiments, the armrest apparatus further comprises a housing to cover the cam locking assembly, the housing having a first part for supporting a stem of the armrest.

In various embodiments, the cam locking assembly comprises: a first plate attached to the mounting plate by a first pivot; a second plate attached to the first plate by a second pivot, the second plate being configured to receive the armrest; wherein the lever comprises a lever rod extending from the second plate, a lever handle attached to the lever rod, and a lever housing to cover the lever rod and a part of the lever handle, wherein the housing is clamped against the mounting plate, lever housing and the first part is clamped against the mounting plate, when the armrest is in the first position. In some embodiments, the first plate and the second plate each comprise L-shaped plates.

In various embodiments, the armrest apparatus further comprises, a partition device operable to separate the lever housing and the first part.

In various embodiments, the armrest apparatus further comprises a stopping pin disposed on the first plate, the stopping pin extending along a part of a perimeter of the second pivot.

In various embodiments, a depression of the lever handle is operable to cause the lever housing to release the clamp against the mounting plate, and upon releasing the clamp against the mounting plate, a first applied force is operable to rotate the first plate about the first pivot, along the lateral plane of the cam locking assembly, and a second applied force is operable to rotate the second plate about the second pivot, along a longitudinal plane of the cam locking assembly. In some embodiments, the first plate is operable to rotate about the first pivot, to a first stopping angle, along the lateral plane of the cam locking assembly, the first stopping angle ranging from 160° to 200°, optionally 180° with respect to the first direction. In some other embodiments, the second plate is operable to rotate about the second pivot, to a second stopping angle, along the longitudinal plane of the cam locking assembly, the second stopping angle ranging from 60° to 120°, optionally 90° with respect to the first direction.

According to a second aspect of the disclosure, there is provided a kit of parts of an armrest apparatus assembly for a furniture item, the kit of parts comprising: a mounting plate comprising a mount; a cam locking assembly configured to be attached to the mounting plate and configured to receive an armrest for the furniture item, wherein the mount is configured to mount the cam locking assembly to a supportive base of the furniture item.

According to a third aspect of the disclosure, there is provided a method of manufacturing an armrest apparatus for a furniture item, the method comprising: providing, a mounting plate comprising a mount; providing, a cam locking assembly attached to the mounting plate and configured to receive an armrest for the furniture item, wherein the mount is configured to mount the cam locking assembly to a supportive base of the furniture item.

In various embodiments, the mount comprises at least one mounting hole arranged on the mounting plate, the at least one mounting hole configured to receive a fastener to mount the cam locking assembly to the supportive base of the furniture item.

In various embodiments, the method further comprises: providing, a housing to cover the cam locking assembly, the housing having a first part for supporting a stem of the armrest; and wherein providing, the cam locking assembly comprises: providing, a first pivot for attaching a first plate to the mounting plate; providing, a second pivot for attaching a second plate to the first plate, the second plate being configured to receive the armrest; providing, the lever comprising a lever rod extending from the second plate, a lever handle attached to the lever rod, and a lever housing to cover the lever rod and a part of the lever handle, wherein the lever housing and the first part is clamped against the mounting plate, when the armrest is in the first position.

In various embodiments, a depression of the lever handle is operable to cause the lever housing to release the clamp against the mounting plate, and upon releasing the clamp against the mounting plate, a first applied force is operable to rotate the first plate about the first pivot, along the lateral plane of the cam locking assembly, and a second applied force is operable to rotate the second plate about the second pivot, along a longitudinal plane of the cam locking assembly.

According to a fourth aspect of the disclosure, there is provided a method of fitting the armrest apparatus of the first aspect, onto a furniture item, the method comprising: aligning, the mount of the mounting plate along an edge of the supportive base of the furniture item; mounting, the mounting plate to the supportive base of the furniture item, using the mount.

In various embodiments of the first to fourth aspects, the furniture item is a chair, and the supportive base is a seat base of the chair.

### BRIEF DESCRIPTION OF THE DRAWINGS

The disclosure will be better understood with reference to the detailed description when considered in conjunction with the non-limiting examples and the accompanying drawings, in which:

FIGS. 1A and 1B show a schematic illustration of an armrest apparatus 100 for a furniture item, and an exemplary housing 150 of the armrest apparatus 100, respectively;

FIGS. 2A and 2B show an exemplary armrest 180 mounted on the armrest apparatus 100, with and without the housing 150, respectively;

FIG. 3 shows a pictorial representation of an exemplary furniture item 500 having the armrest apparatus 100 mounted to the supportive base 502 of the furniture item 500;

FIGS. 4A and 4B show a schematic illustration an armrest apparatus 100 in the first position, with and without the attached armrest 180, and the housing 150, when the lever handle 134 is depressed;

FIGS. 5A and 5B show a schematic illustration of the armrest apparatus 100 rotated about a lateral plane of cam locking assembly 110, with and without the attached armrest 180, and the housing 150, respectively;

FIGS. 6A and 6B show a schematic illustration of the armrest apparatus 100 rotated about a longitudinal plane of the cam locking assembly 110, in the second position, with and without the attached armrest 180, and the housing 150, respectively.

FIG. 7 shows a flowchart of a method of manufacturing 700 an armrest apparatus for a furniture item; and

FIG. 8 shows a flowchart of a method of fitting 800 the armrest apparatus onto the furniture item.

### DETAILED DESCRIPTION

The following detailed description refers to the accompanying drawings that show, by way of illustration, specific details and embodiments in which the disclosure may be practiced. These embodiments are described in sufficient detail to enable those skilled in the art to practice the disclosure. Other embodiments may be utilized and structural, and logical changes may be made without departing from the scope of the disclosure. The various embodiments are not necessarily mutually exclusive, as some embodiments can be combined with one or more other embodiments to form new embodiments.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

While such terms as “first,” “second,” etc., may be used to describe various elements, such elements must not be limited to the above terms. The above terms are used only to distinguish one element from another, and do not define corresponding elements, for example, an order and/or significance of the elements. Without departing a scope of rights of the specification, a first element may be referred to as a second element, and similarly, the second element may be referred to as the first element.

In the context of various embodiments, the articles “a”, “an” and “the” as used with regard to a feature or element include a reference to one or more of the features or elements. As used herein, the term “and/or” includes any and all combinations of one or more of the associated listed items.

In the context of various embodiments, the indicated values, or limit values of the indicated ranges provided below, with regard to the terms “length”, “angles”, may refer to an average of said terms. For example, the indicated values, or limit values of the ranges, for the terms “first length”, “second length”, “first stopping angle”, “second stopping angle”, may refer to the average value, or average limit value of the range.

Throughout the description, the term “furniture item”, as used herein, may refer to articles suitable for supporting a user and/or providing comfort to a user. The furniture item may refer to household or office furniture items such as but not limited to a chair, a sofa, a recliner. In various embodiments, the chair may include an ergonomic chair, for example, a gaming chair, an office chair, a dining chair.

Throughout the description, the term “supportive base”, as used herein, may refer to a part of the furniture item that is designed for bearing at least, a weight of the user, and to provide comfort for the user, by allowing the user to rest, e.g. sit, recline, on the supportive base. In various embodiments, the supportive base may refer to the seat base of the furniture item. Accordingly, within the context of the disclosure, the term “seat base” may include the seat comprising the cushion or padding of the seat, and the frame on which the cushion or padding is supported on.

Throughout the description, the term “first, e.g. upright position”, as used herein, may refer to a position of the armrest in a non-folded position, when the armrest is positioned to support the user's arm, such that a user may rest their arm on the armrest. In the first position, the armrest may extend from the mounting plate in a first direction, for example, an “upward” direction with respect to a supportive base of the furniture item.

Throughout the description, the term “second, e.g. retracted position”, as used herein, may refer to a position of the armrest in a folded position, when the armrest is retracted or reclined away from the seat base as desired by a user. In the second position, the armrest may extend from the mounting plate in a second direction different to the first direction, for example, a “sideward” direction with respect to a supportive base of the furniture item.

Throughout the description, the term “operable to”, as used herein, may refer to being able to be used and function in a certain manner. The term “operable to” may also mean, being configured to, being arranged to, being formed or provided to, function in a certain manner.

Throughout the description, the term “substantially perpendicular”, as used herein, may refer to an angle ranging from 80° to 100°, optionally, 90°. That is, the second direction (when the armrest is in the second, e.g. retracted position) may be at an angle ranging from 60° to 120°, optionally, 90°, with respect to the first direction (when the armrest is in the first, e.g. upright position).

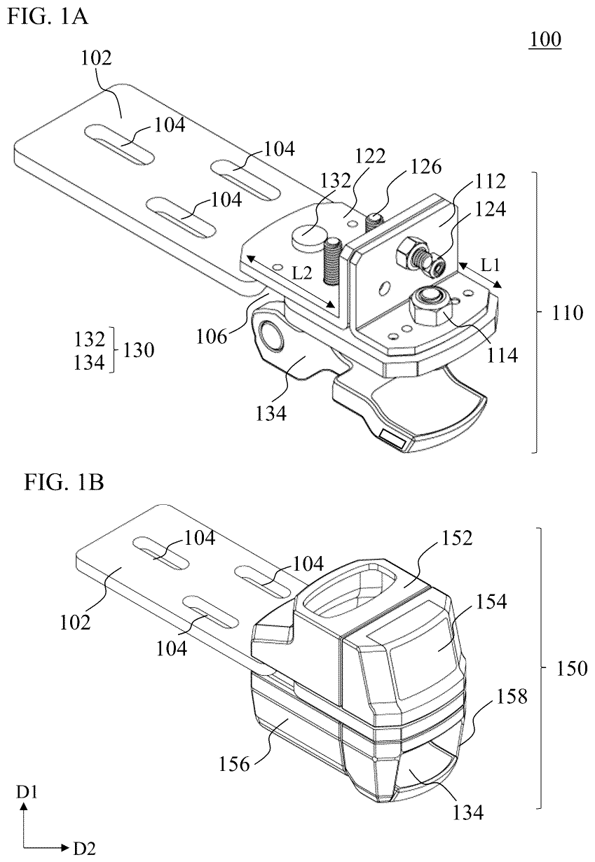

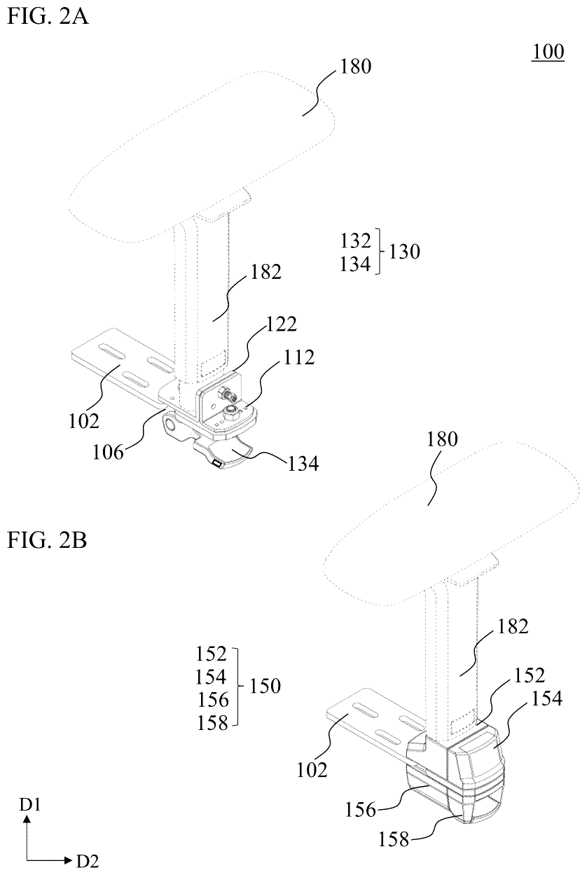

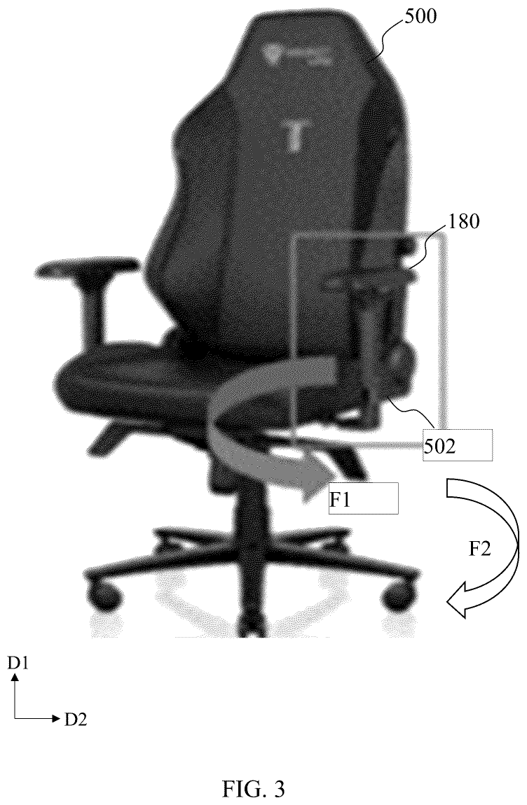

FIGS. 1A and 1B show a schematic illustration of an armrest apparatus 100 for a furniture item, and an exemplary housing 150 of the armrest apparatus 100, respectively. FIGS. 2A and 2B show an exemplary armrest 180 mounted on the armrest apparatus 100, with and without the housing 150, respectively. FIG. 3 shows a pictorial representation of an exemplary furniture item 500 having the armrest apparatus 100 mounted to the supportive base 502 of the furniture item 500.

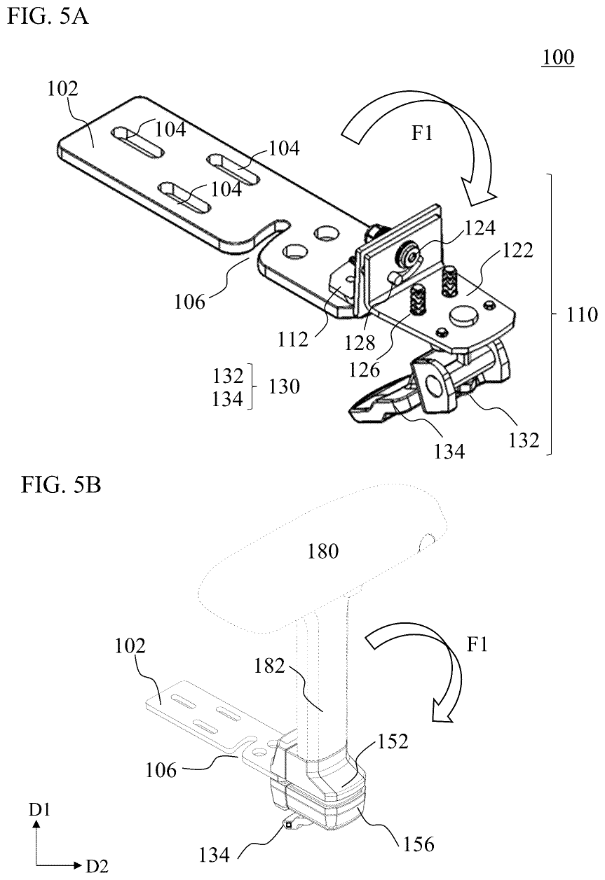

In various embodiments, the furniture item 500 may be a chair, and the supportive base 502 of the furniture item 500 may be a seat base, as shown in FIG. 5B. The seat base may include the frame on which the seat is supported on, and the seat itself.

Referring to FIGS. 1A to 3, the armrest apparatus 100 comprises a mounting plate 102 comprising a mount 104. A cam locking assembly 110 may be disposed on and attached to the mounting plate 102, and configured to receive an armrest 180.

The mount 104 is configured to enable the cam locking assembly 110 to be mounted to a supportive base 502 of a furniture item 500. In various embodiments, the mount 104 may enable the cam locking assembly 110 to be mounted to the frame of the seat, and/or may enable the cam locking assembly 110 to be mounted directly on the seat itself.

The mount 104 may comprise at least one mounting hole/slot arranged on the mounting plate 102. For example, the mounting plate 102 may include a plurality, e.g. three, mounting holes arranged thereon. The mounting holes may be configured to receive one or more fasteners, e.g. screws, which may be threaded through the mounting holes to enable the cam locking assembly 110 and the armrest 180 to be mounted to the supportive base 502. In some embodiments, the mounting holes may comprise an elongated shaped, e.g. pill-shaped hole. This may ease the assembly process of mounting the mounting plate 102 to the supportive base 502 of the furniture item 500. It is contemplated that the mount 104 may include a bracket, and adhesive means, and/or any other suitable means for enabling the cam locking assembly 110 and the armrest 180 to be mounted to the supportive base 502 of the furniture item 500.

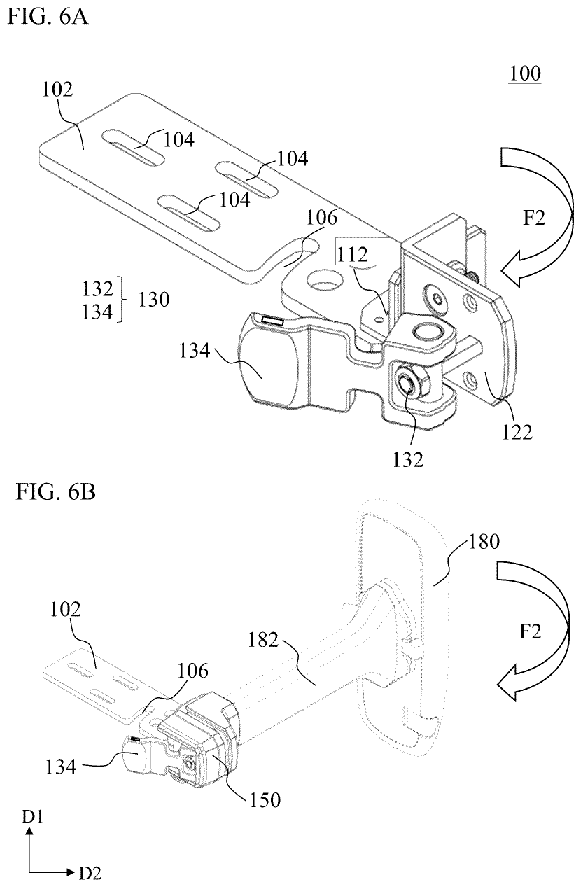

The mounting plate 102 may further include a slot 106 arranged on the mounting plate 102, and configured to receive a part of a lever 130 of the cam locking assembly 110 (see FIGS. 5A and 6A). In various embodiments, the lever rod 132 may be held within the slot 106, in the first, e.g. upright position.

As shown in FIGS. 1A and 2A, the cam locking assembly 110 may comprise a first plate 112 attached to the mounting plate 102 by a first pivot 114, and a second plate 122 attached to the first plate 112 by a second pivot 124. In various embodiments, the first plate 112 and the second plate 122 may each comprise an L-shaped plate. A length L1 of a part of the first plate 112 may be shorter than a length L2 of a part of the second plate 122. For example, a length L1 of the first plate 112 may range from 2 cm to 4 cm, preferably ranging from 2.5 cm to 3 cm, and a length L2 of the second plate 122 may range from 4.5 cm to 7 cm, preferably ranging from 5.5 cm to 6 cm.

Each of the first 114 and second 124 pivots may include a hinge or any other suitable means that enables the first plate 112 and the second plate 122 to rotate about said first 114 and second 124 pivots, respectively. In other words, the first 114 and second 124 pivots form a pivot point on which the first plate 112 and the second plate 124 are rotatable. In various embodiments, a stopping pin 128 may be disposed on the first plate 112 to extend along a part of the perimeter of the second pivot 124 (see FIG. 5A).

The second plate 122 may be configured to receive and support the armrest 180, and may include an armrest fastener 126, e.g. threaded screws for stably mounting the armrest 180 to the second plate 122 (see FIG. 3). In various embodiments, the armrest 180 may be fixed on to the second plate 122, such that the armrest 180 is not rotatable or moveable. As such, the armrest 180 may stably support the user's arm, in a first, e.g. upright position.

As shown in FIGS. 1B and 2B, the armrest apparatus 100 may further comprise a housing 150 to house the cam locking assembly 110. The housing 150 may comprise a first part 152, a second part 154, a lever housing 156 and a fourth part 158, which may be fitted with each other to house the cam locking assembly 110. The first part 152 may cover a part of a stem 182 of the armrest 180, and may support the stem 182 of the armrest 180. The housing 150 may also provide additional support for the armrest 180 as it moves between the first, e.g. upright position and the second, e.g. retracted position.

The cam locking assembly 110 may further comprise a lever 130 operable to move the armrest 180 from a first, e.g. upright or non-folded position, to a second, e.g. retracted or folded position. The lever 130 may comprise a lever rod 132 extending from the second plate 122, and a lever handle 134 attached to the lever rod 132. For example, the lever rod 132 may threaded through an aperture of the lever handle 134 (see FIG. 6A). The lever 130 may further comprise the lever housing 156 which covers the lever rod 132 and a part of the lever handle 134. The lever handle 134 may not be fully housed in the housing 150, to allow a user to easily access the lever handle 134 for moving the armrest 180 from the first, e.g. upright position, into the second, e.g. retracted position.

In the first, e.g. upright position, as shown in FIGS. 2A and 2B, the lever housing 156 and the first part 152 may be clamped against the mounting plate 102. In this position, the lever rod 132 may be held within the slot 106 of the mounting plate 102. In the first, e.g. upright position, the lever housing 156 and the first part 152 may cooperate to apply a “clamping force”, e.g. compressive force against the mounting plate 102 to hold the armrest 180 in the first, e.g. upright position. The lever housing 156 and first part 152 may therefore function as a clamp to hold the second plate 122 having the armrest 180 fixed thereon, in the first, e.g. upright position, and may be operable to move the armrest 180 into the second, e.g. retracted position. The clamping of the lever housing 156 and the first part 152 against the mounting plate 102 may also secure and lock the second plate 122 having the armrest 180 attached thereto, to provide a stable armrest 180 from supporting a user's arm.

In the first, e.g. upright position, the armrest 180 may extend from the mounting plate 102 in a first direction D1. The first direction D1 may be an “upward” direction, with respect to the supportive base 502 of the furniture item 500 (see FIG. 3). In the second, e.g. retracted position, the armrest 180 may extend from the mounting plate 102 in a second direction D2 different to the first direction D1. The second direction D2 may be substantially perpendicular to the first direction D1. For example, the second direction D2 may be at an angle ranging from 80° to 100°, optionally, 90° with respect to the first direction D1. The second direction D2 may be a “sideward” direction, with respect to the supportive base 502 of the furniture item (see FIG. 3).

In various embodiments, the lever 130 may comprise a partition device, e.g. spring, configured to separate the lever housing 156 from the first part 152 of the housing 150. The partition device may be used to separate the lever housing 156 from the first part 152 in the first, e.g. upright position, and may facilitate the further separation of the lever housing 156 from the first part 152, when the lever handle 134 is depressed, as will be explained below.

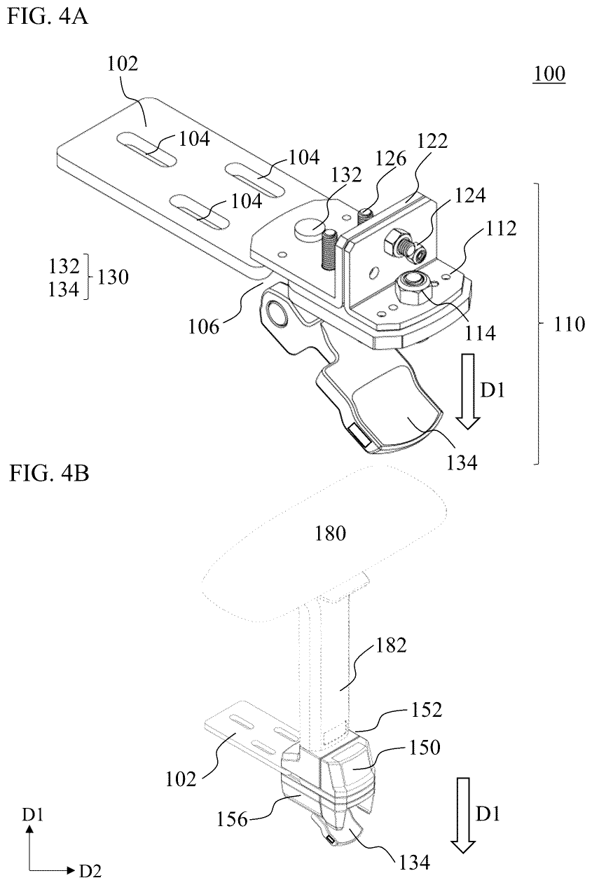

FIGS. 4A to 6B show the schematic illustrations of the armrest apparatus 100 as it moves the armrest 180 from a first, e.g. upright position (see FIGS. 4A and 4B) to a second, e.g. retracted position (see FIGS. 6A and 6B). In various embodiments, a depression of the lever handle 134 is operable to move the armrest 180 from the first, e.g. upright to the second, e.g. retracted position.

FIGS. 4A and 4B show a schematic illustration an armrest apparatus 100 in the first position, with and without the attached armrest 180, and the housing 150, respectively, when the lever handle 134 is depressed. FIGS. 5A and 5B show a schematic illustration of the armrest apparatus 100 rotated about a lateral plane of cam locking assembly 110, with and without the attached armrest 180, and the housing 150, respectively. FIGS. 6A and 6B show a schematic illustration of the armrest apparatus 100 rotated about a longitudinal plane of the cam locking assembly 110, in the second position, with and without the attached armrest 180, and the housing 150, respectively.

Referring to FIGS. 4A and 4B, a depression D1, e.g. via an external applied force by the user, in which the lever handle 134 moves away, e.g. distal from the second plate 122, may cause the cam locking assembly 110 to release the clamping force against from the mounting plate 102. In various embodiments, a depression of the lever handle 134 pulls the lever rod 134 away in a direction opposing the first direction D1, e.g. a “downward” direction with respect to the supportive base 502 (see FIG. 3), to cause the lever housing 156 to move away from the mounting plate 102 in the first direction D1, e.g. “downward” direction with respect to the supportive base 502 (see FIG. 3), thereby releasing the clamp against the mounting plate 102. In other words, the lever housing 156 is no longer clamped against and in direct contact with the mounting plate 102. This releases the cam locking assembly 110, and allows for the dual-axis rotation along the lateral and longitudinal planes of the cam locking assembly 110. In various embodiments, the depression of the lever handle 134 may be further operable to cause the partition device, e.g. spring, to extend in the first direction D1, to facilitate the movement of the lever housing 156 away from the mounting plate 102.

Referring to FIGS. 5A and 5B, upon the release of the clamping force applied by the lever housing 156 against the mounting plate 102, a first applied force F1 may be operable to rotate the first plate 112 about the first pivot 114, along the lateral plane of the cam locking assembly 110. The first applied force F1 may be provided by a user's hand which pushes the armrest 180 such that the lever rod 132 moves from, e.g. slides out of, the slot 106, to cause the first plate 112 to rotate about the first pivot 114. Since the first pivot 114 attaches the first plate 112 to the mounting plate 102, the first plate 112 rotates along the lateral or horizontal plane of the cam locking assembly 110. In other words, the first plate 112 and the second plate 122 (having the attached armrest 180) connected thereto, may rotate “outwards” with respect to the supportive base 502 of the furniture item 500 (see FIG. 3). In this position, the armrest 180 may extend from the mounting plate 102 in the first direction D1 (see FIG. 5B), since the rotation of the first plate 112 and second plate 122 are along the lateral plane of the cam locking assembly 110.

The first plate 112 may be operable to rotate about the first pivot 114, to a first stopping angle along the lateral plane of the cam locking assembly 110. In various embodiments, the first stopping angle may range from 160° to 200° with respect to the first direction, and in some embodiments, may be 180° with respect to the first direction. In some embodiments, it is contemplated that another stopping pin may be provided to prevent the first plate 112 from over-rotating, to an angle more than 200°.

Referring to FIGS. 6A and 6B, after the first plate 112 is rotated along the lateral plane of the cam locking assembly 110, a second applied force F2 may be operable to rotate the second plate 122 about the second pivot 124. along the longitudinal plane of the cam locking assembly 110. The second applied force F2 may be provided by a user's hand which causes the second plate 122 having the attached armrest 180, to rotate along the longitudinal or vertical plane of the cam locking assembly 110. That is, the second plate 122 rotates with respect to the first plate 112, which is mounted to the mounting plate 102, and remains stationary. In other words, the second plate 122 having the attached armrest 180, may rotate “sideward” with respects to the supportive base 502 of the furniture item 500 (see FIG. 3), to move into the second, e.g. retracted position. Accordingly, in the second, e.g. retracted position, the armrest 180 may extend from the mounting plate 102 is the second direction D2, which may be substantially perpendicular to the first direction D1.

The second plate 122 may be operable to rotate about the second pivot 124, to a second stopping angle along the longitudinal plane of the cam locking assembly 110. In various embodiments, the second stopping angle may range from 60° to 120°, and in some embodiments, may be 90°, with respect to the first direction. In various embodiments, the stopping pin 128 which extends along a part of the perimeter of the second pivot 124, may be configured to prevent the second plate 122 from over-rotating, to an angle more than 120°.

Accordingly, in the second, e.g. retracted position, the armrest 180 may be tucked neatly at the side of the furniture item 500, and may not hinder access and adjustment of the various other levers which are situated at the bottom, e.g. proximal to the base of the furniture item 500. This may also be aesthetically appealing to the user, and allows for the free articulation of the user's arm when desired.

To move the armrest 180 from the second, e.g. retracted position to the first, e.g. upright position, a user may first, rotate the second plate 122 with the armrest 180 attached thereto, about the second pivot 124 along the longitudinal or vertical plane of the cam locking assembly 110. The second plate 122 may be rotated while the first plate 112 remains stationary. In other words, the second plate 122 may be rotated “sideward” away from the supportive base 502 of the furniture item. Accordingly, the armrest 180 which extends from the mounting plate 102 in the second direction D2 may move to extend from the mounting plate 102 in the first direction D1 (see position in FIG. 5B).

A user may then, rotate the first plate 112 about the first pivot 114 along the lateral or horizontal plane of the cam locking assembly 110. As the first plate 112 is connected to the second plate 122 having the attached armrest 180, the rotation of the first plate 112 causes the second plate 122 to rotate along with the first plate 112. In other words, the first plate 112 may be rotated “inwards” with respect to the supportive base 502 of the furniture item 500. Accordingly, the armrest 180 may move into the first, e.g. upright position, in which the armrest 180 extends from the mounting plate 102 in the first direction D1. In this position, the lever housing 156 may also move towards the mounting plate 102, to cooperate with the first part 152 to clamp against the mounting plate 102 for stabilizing the armrest 180 in the first, e.g. upright position.

According to a second aspect of the disclosure, there is provided a kit of parts of an armrest apparatus assembly for a furniture item. The armrest apparatus assembly may refer to the armrest apparatus 100 discussed with reference to FIGS. 1A to 6B.

The kit of parts comprises: a mounting plate comprising a mount; a cam locking assembly configured to be attached to the mounting plate and configured to receive an armrest for the furniture item, wherein the mount is configured to mount the cam locking assembly to a supportive base of the furniture item.

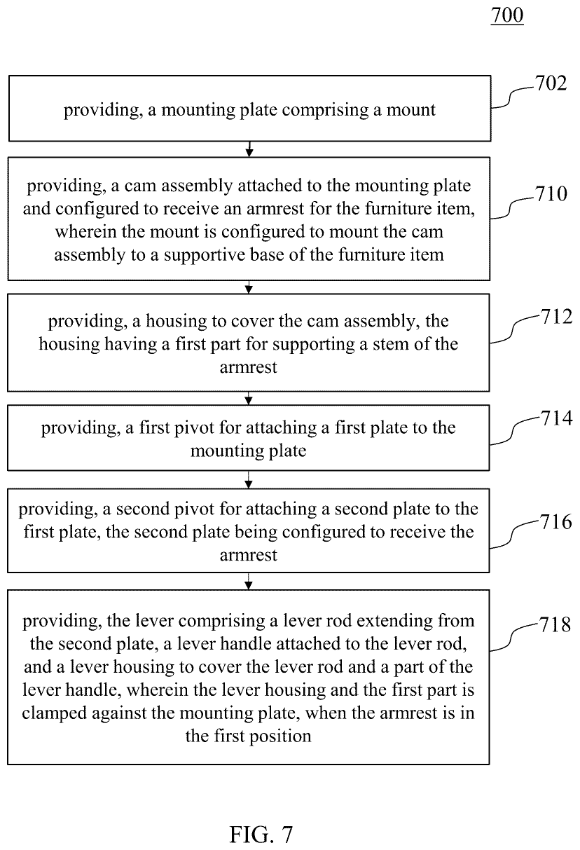

FIG. 7 shows a flowchart of a method of manufacturing 700 an armrest apparatus for a furniture item. The armrest apparatus and the furniture item may refer to armrest apparatus 100 and furniture item 500 discussed with reference to FIGS. 1A to 6B.

Method 700 comprises: providing, a mounting plate comprising a mount (step 702); providing, a cam locking assembly attached to the mounting plate and configured to receive an armrest for the furniture item, wherein the mount is configured to mount the cam locking assembly to a supportive base of the furniture item (step 710).

In various embodiments, the second direction is substantially perpendicular to the first direction.

In various embodiments, the mount may comprise at least one mounting hole/slot arranged on the mounting plate, the at least one mounting hole configured to receive a fastener to mount the cam locking assembly to the supportive base of the furniture item. In some embodiments, the at least one mounting hole may comprise at least one elongated shaped hole.

In various embodiments, the cam locking assembly comprises a lever operable to move the armrest from a first position in which the armrest extends from the mounting plate in a first direction, and a second position in which the armrest extends from the mounting plate in a second direction different to the first direction.

In various embodiments, method 700 may further comprise: providing, a housing to cover the cam locking assembly, the housing having a first part for supporting a stem of the armrest (step 712); providing, a first pivot for attaching a first plate to the mounting plate (step 714); providing, a second pivot for attaching a second plate to the first plate, the second plate being configured to receive the armrest (step 716); providing, the lever comprising a lever rod extending from the second plate, a lever handle attached to the lever rod, and a lever housing to cover the lever rod and a part of the lever handle, wherein the lever housing and the first part is clamped against the mounting plate, when the armrest is in the first, e.g. upright position (step 718). In some embodiments, the first plate and the second plate each comprise L-shaped plates.

In various embodiments, method 700 may further comprise: providing, a partition device operable to separate the lever housing and the first part.

In various embodiments, method 700 may further comprise: providing, a stopping pin disposed on the first plate, the stopping pin extending along a part of a perimeter of the second pivot.

In various embodiments, a depression of the lever handle is operable to cause the lever housing to release the clamp against the mounting plate, and upon releasing the clamp against the mounting plate, a first applied force is operable to rotate the first plate about the first pivot, along the lateral plane of the cam locking assembly, and a second applied force is operable to rotate the second plate about the second pivot, along a longitudinal plane of the cam locking assembly.

In various embodiments, the first plate is operable to rotate about the first pivot, to a first stopping angle, along the lateral plane of the cam locking assembly, the first stopping angle ranging from 160° to 200°, optionally 180°, with respect to the first direction. In various other embodiments, the second plate is operable to rotate about the second pivot, to a second stopping angle, along the longitudinal plane of the cam locking assembly, the second stopping angle ranging from 60° to 120°, optionally 90°, with respect to the first direction.

In various embodiments, the furniture item comprises a chair, and the supportive base comprises a seat base of the chair.

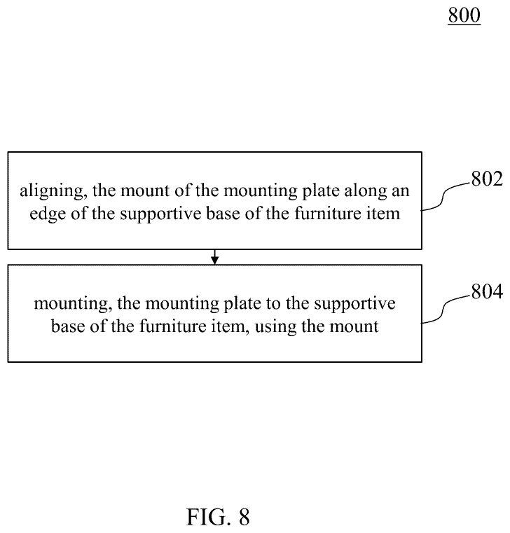

FIG. 8 shows a flowchart of a method of fitting 800 the armrest apparatus onto the furniture item, according to a fourth aspect of the disclosure. The armrest apparatus may refer to armrest apparatus 100, and furniture item may refer to furniture item 500 discussed with reference to FIGS. 1A to 6B.

Method 800 comprises: aligning, the mount of the mounting plate along an edge, e.g. a side of the supportive base of the furniture item (step 802); and mounting, the mounting plate to the supportive base of the furniture item, using the mount (step 804).

Various embodiments of the disclosure thus provide an improved armrest apparatus for a furniture item. The improved armrest apparatus includes a mount for enabling the cam locking assembly to be mounted to a supportive base of the furniture item, thereby providing a narrower distance, e.g. 0 cm-2.5 cm, between the supportive base of the furniture item and the armrest. For example, the armrest may be in direct contact with the supportive base of the furniture item. This provides a stable armrest which retains optimal ergonomic support for supporting the user's arm in the first, e.g. upright or non-folded position, as the user no longer has to extend their arm outwards to rest their arm on the armrest, and provides an armrest which is able to move into the second, e.g. retracted or folded position when desired.

Furthermore, the cam locking assembly of the improved armrest apparatus features a two-axis rotation, e.g. swivel mechanism for moving the armrest into the second, e.g. retracted position—by rotating the armrest along the lateral and longitudinal planes of the cam locking assembly. The two-axis rotation mechanism allows the armrest to retract with sufficient clearance, and enables the armrest to be stably supported in the first, e.g. upright position.

The improved armrest apparatus thus provides a foldable armrest that provides optimal ergonomic support for the user, and provides a dual-axis rotation mechanism for retracting the armrest into the second, e.g. retracted position. In addition, a simple and inexpensive manufacturing process of the improved armrest apparatus is provided.

While the disclosure has been particularly shown and described with reference to specific embodiments, it should be understood by those skilled in the art that various changes in form and detail may be made therein without departing from the spirit and scope of the disclosure as defined by the appended claims. The scope of the disclosure is thus indicated by the appended claims and all changes which come within the meaning and range of equivalency of the claims are therefore intended to be embraced.

1. An armrest apparatus for a furniture item, the armrest apparatus comprising
a mounting plate comprising a mount;
a cam locking assembly attached to the mounting plate and configured to receive an armrest for the furniture item,
wherein the mount is configured to mount the cam locking assembly to a supportive base of the furniture item.

2. The armrest apparatus of claim 1, wherein the mount comprises at least one mounting hole arranged on the mounting plate, the at least one mounting hole configured to receive a fastener to mount the cam locking assembly to the supportive base of the furniture item.

3. The armrest apparatus of claim 2, wherein the at least one mounting hole comprises at least one elongated shaped hole.

4. The armrest apparatus of claim 1, wherein the cam locking assembly comprises a lever operable to move the armrest from a first position in which the armrest extends from the mounting plate in a first direction, and a second position in which the armrest extends from the mounting plate in a second direction different to the first direction.

5. The armrest apparatus of claim 4, wherein the second direction is substantially perpendicular to the first direction.

6. The armrest apparatus of claim 1, further comprising a housing to cover the cam locking assembly, the housing having a first part for supporting a stem of the armrest.

7. The armrest apparatus of claim 6, wherein the cam locking assembly comprises
a first plate attached to the mounting plate by a first pivot;
a second plate attached to the first plate by a second pivot, the second plate being configured to receive the armrest;
wherein the lever comprises a lever rod extending from the second plate, a lever handle attached to the lever rod, and a lever housing to cover the lever rod and a part of the lever handle,
wherein the lever housing and the first part is clamped against the mounting plate, when the armrest is in the first position.

8. The armrest apparatus of claim 7, further comprising a partition device operable to separate the lever housing and first part.

9. The armrest apparatus of claim 7, further comprising a stopping pin disposed on the first plate, the stopping pin extending along a part of a perimeter of the second pivot.

10. The armrest apparatus of claim 7, wherein a depression of the lever handle is operable to cause the lever housing to release the clamp against the mounting plate, and upon releasing the clamp against the mounting plate,
a first applied force is operable to rotate the first plate about the first pivot, along the lateral plane of the cam locking assembly, and
a second applied force is operable to rotate the second plate about the second pivot, along a longitudinal plane of the cam locking assembly.

11. The armrest apparatus of claim 10, wherein the first plate is operable to rotate about the first pivot, to a first stopping angle, along the lateral plane of the cam locking assembly, the first stopping angle ranging from 160° to 200°, optionally 180°, with respect to the first direction.

12. The armrest apparatus of claim 10, wherein the second plate is operable to rotate about the second pivot, to a second stopping angle, along the longitudinal plane of the cam locking assembly, the second stopping angle ranging from 60° to 120°, optionally 90° with respect to the first direction.

13. The armrest apparatus of claim 7, wherein the first plate and the second plate each comprise L-shaped plates.

14. The armrest apparatus of claim 1, wherein the furniture item comprises a chair, and the supportive base comprises a seat base of the chair.

15. A kit of parts of an armrest apparatus assembly for a furniture item, the kit of parts comprising
a mounting plate comprising a mount;
a cam locking assembly configured to be attached to the mounting plate and configured to receive an armrest for the furniture item,
wherein the mount is configured to mount the cam locking assembly to a supportive base of the furniture item.

16. A method of manufacturing an armrest apparatus for a furniture item, the method comprising
providing, a mounting plate comprising a mount;
providing, a cam locking assembly attached to the mounting plate and configured to receive an armrest for the furniture item,
wherein the mount is configured to mount the cam locking assembly to a supportive base of the furniture item.

17. The method of claim 16, wherein the cam locking assembly comprises a lever operable to move the armrest from a first position in which the armrest extends from the mounting plate in a first direction, and a second position in which the armrest extends from the mounting plate in a second direction different to the first direction.

18. The method of claim 17, further comprising
providing, a housing to cover the cam locking assembly, the housing having a first part for supporting a stem of the armrest
wherein providing, the cam locking assembly comprises
providing, a first pivot for attaching a first plate to the mounting plate;
providing, a second pivot for attaching a second plate to the first plate, the second plate being configured to receive the armrest;
providing, the lever comprising a lever rod extending from the second plate, a lever handle attached to the lever rod, and a lever housing to cover the lever rod and a part of the lever handle,
wherein the lever housing and the first part is clamped against the mounting plate, when the armrest is in the first position.

19. The method of claim 18, wherein a depression of the lever handle is operable to cause the lever housing to release the clamp against the mounting plate, and upon releasing the clamp against the mounting plate,
a first applied force is operable to rotate the first plate about the first pivot, along the lateral plane of the cam locking assembly, and
a second applied force is operable to rotate the second plate about the second pivot, along a longitudinal plane of the cam locking assembly.

20. A method of fitting an armrest apparatus onto the furniture item, the armrest apparatus comprising:
a mounting plate comprising a mount; and
a cam locking assembly attached to the mounting plate and configured to receive an armrest for the furniture item;
wherein the mount is configured to mount the cam locking assembly to a supportive base of the furniture item;
the method comprising
aligning the mount of the mounting plate along an edge of the supportive base of the furniture item; and
mounting the mounting plate to the supportive base of the furniture item, using the mount.
